(19) United States
(12) Patent Application Publication
(10) Pub. No.: US 2008/0254326 A1
(43) Pub. Date: Oct. 16, 2008

(54) Method and a System for Producing, Converting and Storing Energy

(76) Inventors: Dan Borgstrom, Karlskoga (SE); Olof Dahlberg, Vintrosa (SE)

Correspondence Address: PILLSBURY WINTHROP SHAW PITTMAN, LLP, P.O. BOX 10500, MCLEAN, VA, 22102, US

(21) Appl. No.: 12/088,795

(22) PCT Filed: Oct. 13, 2006
(86) PCT No.: PCT/SE2006/050401

§ 371 Date: Mar. 31, 2008

(30) Foreign Application Priority Data
Oct. 14, 2005 (SE) 0502295-9

(51) Int. Cl. H01M 8/04; H01M 8/18

(52) U.S. Cl. 429/17; 429/19

(57) ABSTRACT

The invention relates to a method and a system of converting and storing energy. Energy in the form of, for example, wind power or solar energy is used to convert carbon dioxide to methyl alcohol in an electrochemical cell. The methyl alcohol may later be used to produce electricity in a fuel cell.

### FIELD OF THE INVENTION

The invention relates generally to a method and a system for producing and storing energy, for example energy generated by a wind power plant.

### BACKGROUND OF THE INVENTION

In order to reduce the dependency on fossil fuels such as oil, it is desirable to find more effective ways of using renewable sources of energy. One renewable source of energy is wind power. However, wind power is associated with the problem that the wind is unpredictable and that it is not always available at the time it is needed most. In order to provide a safeguard for such occasions when there is no wind available, it may still be necessary to have the option of using power plants relying on fossil fuels or nuclear energy. Consequently, in terms of installed capacity, it is difficult to replace other energy sources with wind power. It is an object of the present invention to provide a way of converting and storing energy such that energy from for example wind power plants can be used more effectively. It has previously been suggested in for example WO0025380 that carbon dioxide can be converted into hydrogen gas which may subsequently be converted into a storage compound such as methanol.

### DISCLOSURE OF THE INVENTION

The invention relates to a method of producing, converting and storing energy. The inventive method comprises the steps of generating electrical energy in a power plant (for example a wind power plant), using the electrical energy to convert carbon dioxide and water into methyl alcohol in a fuel cell/an electrochemical cell, storing the methyl alcohol in a tank and converting the stored methyl alcohol into electrical energy in a fuel cell on a later occasion. Since the carbon dioxide is converted to methyl alcohol in the electrochemical cell, further processing can be avoided.

The method includes using at least one electrochemical cell. Preferably, a plurality of electrochemical cells is used. Preferably, the same electrochemical cell or electrochemical cells are used both for producing methyl alcohol and for converting methyl alcohol into electrical energy. It should thus be understood that the electrochemical cells used in the invention may well be capable of operating as fuel cells and produce electricity.

According to one embodiment, fluctuations in the market price of electricity is monitored over time and the market price at a given moment is used to determine if the method shall be used to produce methyl alcohol or for converting stored methyl alcohol into electrical energy.

According to one embodiment, the at least one electrochemical cell or fuel cell is a liquid feed fuel cell (direct methanol fuel cell). Currently used liquid feed fuel cells normally operate at temperatures below 100° C. In that embodiment, the at least one electrochemical cell may comprise an anode and a cathode separated by a polymer membrane. Preferably, the anode is coated by silver and platinum and the cathode is preferably coated by platinum.

According to one embodiment, carbon dioxide that is generated when methyl alcohol is converted into electrical energy is stored in a tank for carbon dioxide.

In another embodiment, the at least one electrochemical cell is a solid oxide fuel cell. Currently, such cells are operated at relatively high temperatures, 650° C. can be seen as a typical temperature in such cases. However, the trend of the development is towards the use of lower temperatures.

Conversion of methyl alcohol to electrical energy may include converting methyl alcohol into hydrogen and subsequently feeding the hydrogen into the electrochemical cell in a process where the hydrogen is used to produce electrical energy. In particular, this may be the case when a solid oxide fuel cell is used.

The invention also relates to a system for producing, converting and storing energy. The system comprises power plant such as a wind power plant and at least one electrochemical cell connected to the power plant in such a way that the electrochemical cell can receive electrical energy from the power plant and convert the electrical energy into methyl alcohol. The system further comprises a storage tank connected to the electrochemical cell such that methyl alcohol produced by the electrochemical cell can be stored adjacent the electrochemical cell and used to produce electrical energy in the at least one electrochemical cell. The electrochemical cell will then operate as a fuel cell that generates electricity.

The at least one electrochemical cell may be a direct methanol fuel cell that comprises an anode and a cathode separated by a polymer membrane, the anode being coated by silver and platinum and the cathode being coated by platinum. The at least one electrochemical cell of the system may also be a solid oxide fuel cell.

According to one embodiment, the system may optionally be provided with an additional separate storage tank adapted to receive and store carbon dioxide.

In one advantageous embodiment, the system may include means for monitoring a predetermined variable and determining whether the system shall be used for producing electrical energy or for producing methyl alcohol depending on a detected value of the predetermined variable.

### DESCRIPTION OF THE DRAWINGS

FIG. 1 shows schematically a system for generating and storing energy.

FIG. 2 is a schematic representation of a process where a direct methanol fuel cell is operated to generate electrical energy by using methyl alcohol (methanol) as a fuel.

FIG. 3 is a schematic representation of a process where electrical energy is used in a direct methanol fuel cell to convert water and carbon dioxide into methyl alcohol

FIG. 4 is a schematic representation of a process where a solid oxide fuel cell is operated to generate electrical energy by using methyl alcohol as a fuel.

FIG. 5 is a schematic representation of a process where electrical energy is used in a solid oxide fuel cell to convert water and carbon dioxide into methyl alcohol.

### DETAILED DESCRIPTION OF THE INVENTION

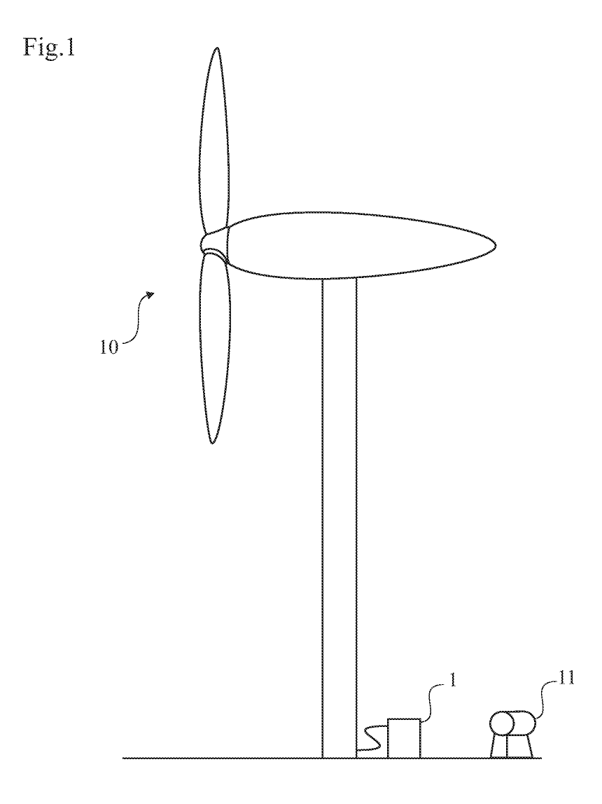

The invention shall initially be explained with reference to FIG. 1 In FIG. 1, the reference numeral 10 is used to designate a power plant which is shown as a wind power plant in FIG. 1. A electrochemical cell 1 is connected to the power plant 10. When the wind power plant 10 is operated, electrical energy is generated. This electrical energy can be fed to the electrochemical cell 1 and used in a process where carbon dioxide and water is used to produce methyl alcohol. The methyl alcohol represents energy that can be stored in a tank 11 and used in the electrochemical cell 1 at a later time to produce electrical energy. The electrochemical cell 1 will then operate as a fuel cell 1. Optionally, a separate fuel cell may be used for the conversion of methyl alcohol to electrical energy. The electrochemical cell 1 used in the invention may be formed by or comprise a number of fuel cell units, for example a number of serially connected fuel cell units.

In FIG. 1, only one electrochemical cell 1 is indicated. However, it should be understood that a plurality of electrochemical cells 1 may be used. Preferably, the same electrochemical cell(s) 1 is/are used both for producing methyl alcohol and for converting methyl alcohol into electrical energy. However, it is possible to envisage embodiments where one cell (or stack of cells) is used to produce methyl alcohol and a different cell (or stack of cells) is used to produce electrical energy.

When the wind is blowing and more electrical energy is produced than what is needed at the moment, a surplus of electrical energy can be used to manufacture methyl alcohol. When there is no wind, methyl alcohol in the tank 11 can be used to generate electrical energy in the fuel cell(s) 1. An advantageous way of practicing the inventive method may also be to monitor fluctuations in the market price of electricity over time. The market price at a given moment can then be used to determine if the method shall be used to produce methyl alcohol or for converting stored methyl alcohol into electrical energy. When electric power is cheap, the process is used to manufacture methyl alcohol. This can also be done during periods when there is no wind. Electrical energy can then be purchased from an external source and converted to methyl alcohol which is converted to electrical energy when the demand for electricity is high and electricity can be sold at a good price.

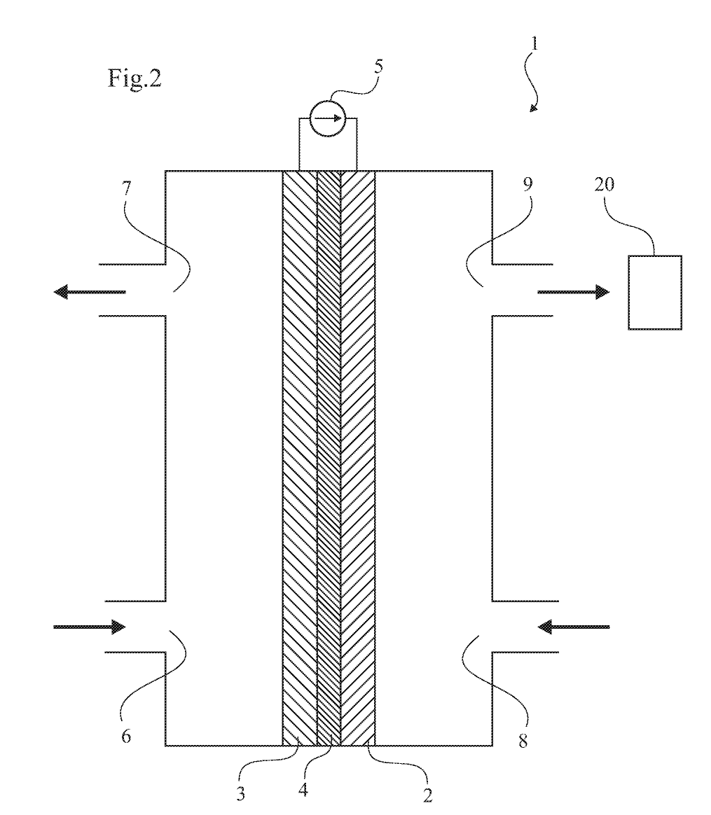

One embodiment of the invention will now be explained with reference to FIG. 2. FIG. 2 illustrates the use of methyl alcohol to produce electrical energy. The electrochemical cell 1 or fuel cell 1 is a direct methanol fuel cell 1 where an anode 2 is separated from the cathode 3 by a membrane 4 that functions as an electrolyte. The membrane 4 is preferably a polymer membrane. The anode 2 is preferably coated by silver and platinum and the cathode 3 is preferably coated by platinum. Instead of being coated by silver and platinum, the anode 2 and the cathode 3 may simply contain these elements. For example, the anode and/or the cathode may comprise a porous material into which the catalyst has been added. In the process of FIG. 2, methyl alcohol and water (CH₃OH+H₂O) is introduced on the anode side through the opening 8. The process generates an electrical current in the circuit 5 and carbon dioxide (CO₂) leaves the anode through opening 9. On the cathode side, water (H₂O) leaves the cell through opening 7 while the arrow at opening 6 represents O₂ or O₂ in air.

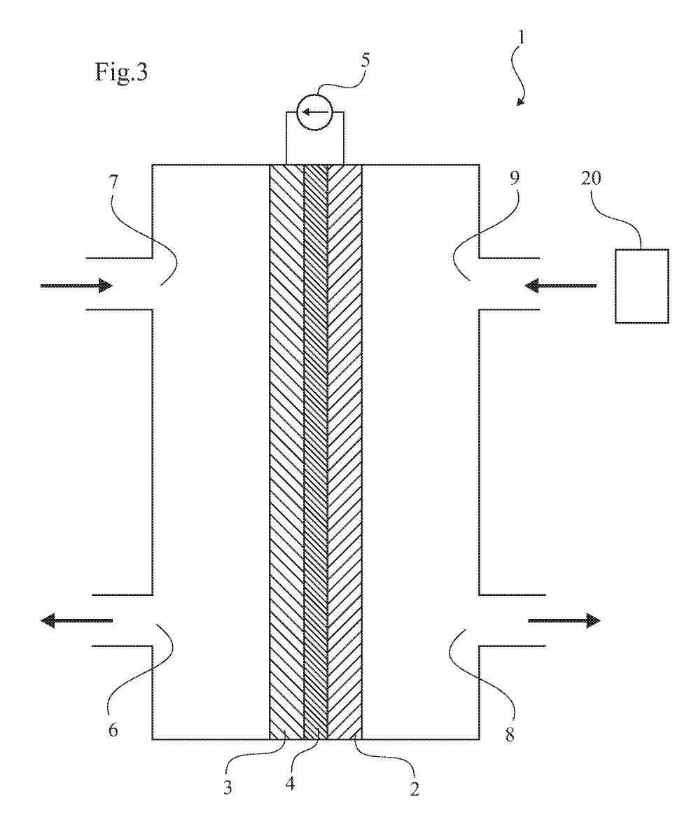

Preferably, the same electrochemical cell 1 is used also in the opposite direction. This case is illustrated in FIG. 3 where electrical energy is supplied to the fuel cell 1 (electrochemical cell 1) through the circuit 5. In the process according to FIG. 3, methyl alcohol and water (CH₃OH+H₂O) is a product of the process that is shown as leaving the fuel cell through opening 8.

The processes illustrated in FIGS. 2 and 3 normally operate at temperatures below 100° C. At such temperatures, the electrolyte may be made of a polymer material. It is believed by the inventors that, when the process is operated at such temperatures, coating of the anode with silver and platinum will improve the efficiency of the process, both when the process is run according to FIG. 2 and when it is run according to FIG. 3. The processes of FIG. 2 and FIG. 3 may operate at a temperature in the range of, for example, 70° C.-80° C. and a pressure of, for example, 1-2 bar (overpressure), i.e. from atmospheric pressure to an overpressure of 1 bar. The processes may also operate at atmospheric pressure or in ranges from atmospheric pressure to 1 bar overpressure. The silver coating has an advantageous effect when the electrochemical cell 1 is used for producing methyl alcohol. The platinum coating functions as a catalyst when an electrical current is generated. If the process takes place at such low temperatures (below 100° C.) and low pressures (e.g. 1-2 bar overpressure), the equipment used does not need to be so strong and the material used can be relatively inexpensive to manufacture.

In the electrochemical cell 1, the conversion of carbon dioxide to methyl alcohol may comprise a number of intermediate steps where the carbon dioxide is first converted to formic acid, the formic acid is transformed into formaldehyde and the formaldehyde into methyl alcohol. However, the entire conversion process can be performed in the electrochemical cell 1. Optionally, the electrochemical cell 1, in which the process is performed may be formed by a fuel cell unit comprising a number of cells that are serially connected. In such a fuel cell unit, a first cell may be optimized for conversion of carbon dioxide to formic acid, a second (subsequent) cell may be optimized for conversion of formic acid to formaldehyde and a third cell may be optimized for conversion of formaldehyde into methyl alcohol. Such a fuel cell unit may be designed in the way disclosed in Swedish patent application No. 0601350-2 which is owned by the proprietor of the present application.

Carbon dioxide that is generated when methyl alcohol is converted into electrical energy may advantageously be stored in a tank 20 for carbon dioxide. The stored carbon dioxide can then be used when it is desired to once again produce methyl alcohol. For production of methyl alcohol, carbon dioxide may then be taken from the tank 20 to the electrochemical cell.

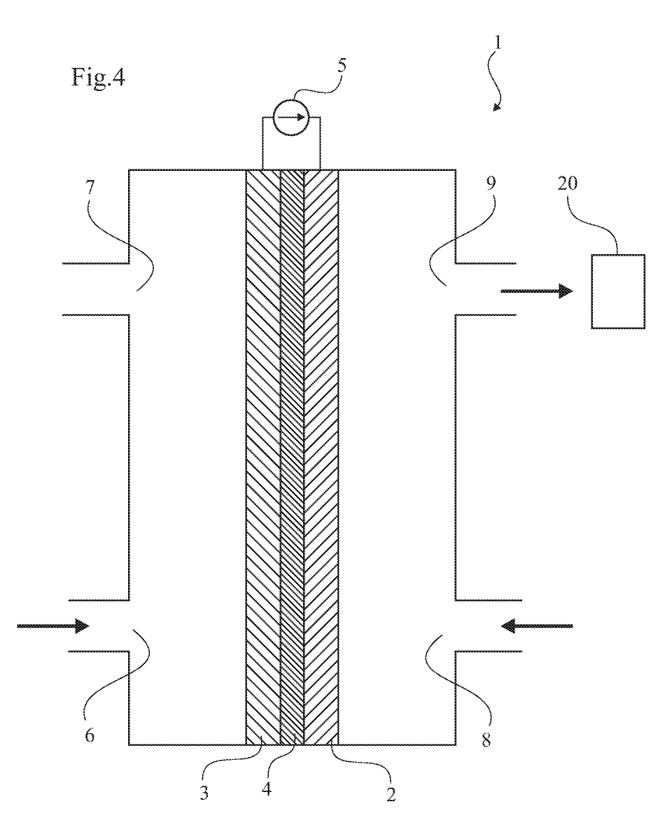

Reference will now be made to FIG. 4 where another embodiment is illustrated. In the embodiment of FIG. 4, the electrochemical cell 1 is a solid oxide fuel cell with the anode 2 and the cathode 3 separated by electrolyte 4. This cell is intended for use at temperatures of 300° C. or more. The operating temperature may be in the range of 400° C.-700° C. but the inventors would consider it as an advantage if the cell could be made to operate at temperatures below 400° C. At temperatures of several hundred degrees, it is believed to be sufficient that the anode 2 and the cathode 3 are simply electrically conductive. In the process illustrated in FIG. 4, Methyl alcohol (CH₃OH) is added on the anode side through opening 8 and air with oxygen or O₂ is fed in through port 6. Excess air and O₂ exit through port 7. Possibly, the methyl alcohol is first converted into hydrogen (H₂) before it is fed to the fuel cell. The process generates electrical energy in circuit 5. Through opening 9, H₂O leaves the fuel cell, alternatively 2H₂O+CO₂. In the process according to FIG. 4, the electrolyte or membrane 4 may be a ceramic membrane that is an anionic conductor. A possible material may be, for example, Yttria stabilized ZrO2 or Ceria-Gadolinium Oxide.

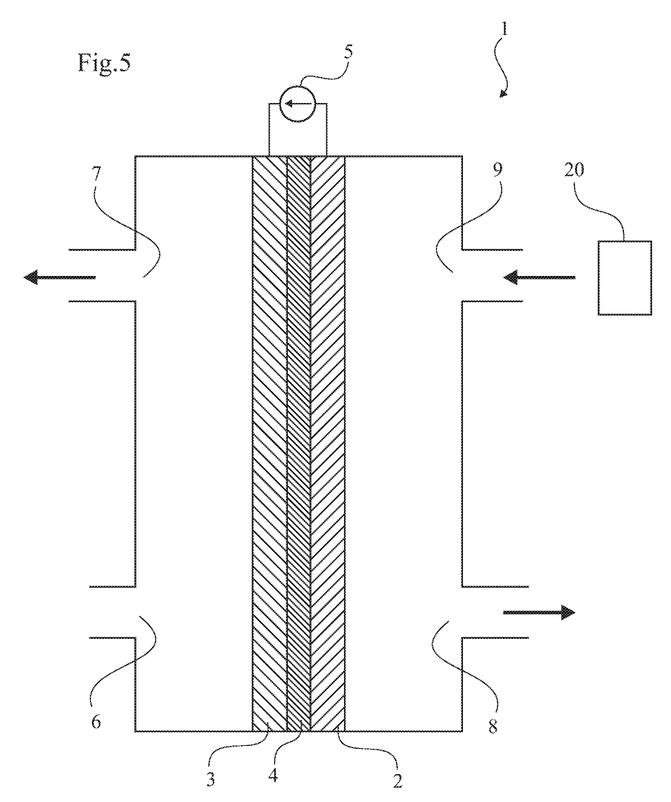

FIG. 5 is a schematic representation of the same electrochemical cell as in FIG. 4. However, in FIG. 5, the process is run in the opposite direction. Consequently, electrical energy is fed to the electrochemical cell 1 which now operates as a fuel cell 1. The electrical energy is fed through circuit 5 and methyl alcohol (CH₃OH) is a product of the process. On the cathode side, air enters through opening 6 and excess air and O₂ leaves the electrochemical cell 1 through opening 7 and carbon dioxide and water (CO₂+2H₂O) is fed to the electrochemical cell through the opening 9.

The system may optionally be provided with an additional separate storage tank adapted to receive and store carbon dioxide. This entails the advantage that carbon dioxide needed to produce methyl alcohol is readily available when needed. Additionally, emissions of carbon dioxide to the ambient atmosphere can be reduced.

In one embodiment, the system includes means for monitoring a predetermined variable and determining whether the system shall be used for producing electrical energy or for producing methyl alcohol depending on a detected value of the predetermined variable. The predetermined variable may be the price of electrical energy. Price fluctuations over time reflect unbalances in the need for electrical energy and the availability of electrical energy. Hence, information about the price can be exploited to make more efficient use of energy, especially energy from such sources as wind power plants. The means for monitoring the predetermined variable may be a computer connected to an internet source of information and arranged to control operation of the electrochemical cell. The predetermined variable could of course also be something else than the price of electricity. For example, it could be power grid frequency imbalance. When an imbalance is detected, the amount of electricity required to balance the power grid is produced. The variable could also be time. In many places, less electrical energy is required during the night. The process could therefore be arranged to store energy during periods when it is expected that less electricity is needed. The variable in question could also be, for example, the availability of wind power. This could be measured in terms of wind speed.

The process and the system described above make it possible to convert carbon dioxide to methyl alcohol without any intermediate step of making hydrogen. If the intermediate step of making hydrogen is eliminated, the process can be made simpler and equipment needed for converting hydrogen to methyl alcohol can be avoided which saves cost. The process according to the present invention where the methyl alcohol is produced directly in the electrochemical cell is thus cost effective.

1) A method of producing, converting and storing energy comprising the steps of:
a) generating electrical energy in a power plant (10) such as a wind power plant (10);
b) using the electrical energy to convert carbon dioxide and water into methyl alcohol in an electrochemical cell (1);
c) storing the methyl alcohol in a tank (11); and
d) at a later occasion, converting the stored methyl alcohol into electrical energy in an electrochemical cell (1).

2) The method of claim 1, wherein a plurality of electrochemical cells (1) is used and the same electrochemical cells (1) are used both for producing methyl alcohol and for converting methyl alcohol into electrical energy.

3) The method of claim 1, wherein fluctuations in the market price of electricity is monitored over time and the market price at a given moment is used to determine if the method shall be used to produce methyl alcohol or for converting stored methyl alcohol into electrical energy.

4) The method of claim 1, wherein at least one electrochemical cell (1) is used and the at least one electrochemical cell (1) is used both for producing methyl alcohol and for converting methyl alcohol into electrical energy and wherein the electrochemical cell is a liquid feed fuel cell (1) (direct methanol fuel cell).

5) The method of claim 4, wherein the at least one electrochemical cell (1) comprises an anode (2) and a cathode (3) separated by a polymer membrane (4), the anode (2) is coated by silver and platinum and the cathode (3) is coated by platinum.

6) The method of claim 1, wherein carbon dioxide that is generated when methyl alcohol is converted into electrical energy is stored in a tank for carbon dioxide.

7) The method of claim 1, wherein at least one fuel cell (1) is used and the at least one electrochemical cell is used both for producing methyl alcohol and for converting methyl alcohol into electrical energy and wherein the electrochemical cell (1) is a solid oxide fuel cell (1).

8) The method of claim 7, wherein conversion of methyl alcohol to electrical energy includes converting methyl alcohol into hydrogen and subsequently feeding the hydrogen into the electrochemical cell (1) in a process where the hydrogen is used to produce electrical energy.

9) A system for producing and storing energy, the system comprising:
a) a power plant (10) such as a wind power plant (10);
b) at least one electrochemical cell (1) connected to the power plant (10) in such a way that the electrochemical cell (1) can receive electrical energy from the power plant (10) and convert the electrical energy into methyl alcohol; and
c) a storage tank (11) connected to the electrochemical cell such that methyl alcohol produced by the electrochemical cell (1) can be stored adjacent the electrochemical cell (1) and used to produce electrical energy in the at least one electrochemical cell (1).

10) The system of claim 9, wherein the at least one electrochemical cell (1) is a direct methanol fuel cell that comprises an anode (2) and a cathode (3) separated by a polymer membrane (4), the anode (2) being coated by silver and platinum and the cathode (3) being coated by platinum.

11) The system of claim 9, wherein the system is further provided with an additional separate storage tank adapted to receive and store carbon dioxide.

12) The system of claim 9, wherein the system includes means for monitoring a predetermined variable and determining whether the system shall be used for producing electrical energy or for producing methyl alcohol depending on a detected value of the predetermined variable.

13) The system of claim 9, wherein the at least one electrochemical cell (1) is a solid oxide fuel cell.
